(19) United States
(12) Patent Application Publication
(10) Pub. No.: US 2025/0314123 A1
(43) Pub. Date: Oct. 9, 2025

(54) Adjustable and Telescopic Cat Gate System with Transparent Net Barrier

(71) Applicant: Evan William Davis, Croydon (AU)

(72) Inventor: Evan William Davis, Croydon (AU)

(21) Appl. No.: 18/628,732

(22) Filed: Apr. 7, 2024

(51) Int. Cl. E06B 7/32; E06B 9/00; E06B 9/06; E06B 11/02

(52) U.S. Cl. CPC E06B 7/32; E06B 11/026; E06B 2009/002; E06B 9/06

(57) ABSTRACT

The present invention relates to a cat gate system designed to selectively restrict or allow passage of cats through a passageway between two opposing walls. The system comprises a pair of horizontal telescopic rods, each equipped with mounting pads at both ends for secure installation between the walls. A fixed side rod, oriented vertically, is secured between the horizontal rods at one end, adjacent to one of the walls. A sliding side rod, also mounted vertically, is capable of sliding between the fixed side rod and the opposite end of the horizontal rods, facilitating adjustable positioning. The system includes a net attached between the fixed and sliding side rods, with the net's top and bottom edges coupled to the horizontal rods.

### FIELD OF INVENTION

The present invention relates generally to pet containment and management devices, specifically to an adjustable, telescopic cat gate system designed for versatile installation in various architectural spaces, including doorways and hallways, featuring a transparent net barrier for visibility and safety.

### BACKGROUND

In the pursuit of maintaining a happy coexistence between humans and pets within domestic spaces, the development and innovation in pet management tools, particularly cat gates, have become a focal point for enhancing household functionality and safety.

Traditional cat gate designs have primarily focused on restricting pet access through standard doorways using fixed or swing-open barriers. However, these conventional solutions have exhibited significant limitations in adaptability, especially in architectural configurations lacking doorways, such as open hallways, or where doorway heights exceed the capabilities of standard gates. Consequently, pet owners have faced challenges in effectively managing their pets' movements within their homes without resorting to confining measures that restrict pets' visibility and freedom.

The limitations of existing cat gate designs stem from a rigid approach to barrier construction, offering little to no flexibility in installation locations, and a lack of consideration for the varied structural layouts of modern homes. Many of these designs are not suited for spaces without pre-existing door frames, thereby limiting their utility to conventional doorways. Additionally, the height of these gates often fails to account for the impressive jumping abilities of cats, rendering them ineffective as a containment measure. This inadequacy not only compromises the primary function of these gates but also prompts pet owners to seek alternative, often less practical, solutions.

Moreover, the operational mechanisms of traditional cat gates, predominantly hinged swing doors, require a clear area for the gate to open into, further constraining their applicability in tight spaces or crowded environments. This mechanical simplicity, while beneficial in terms of ease of use, does not cater to the nuanced needs of pet owners who require a more adaptable and less intrusive means of managing their pets' indoor movements.

The recognized need for a more versatile, space-efficient, and height-adjustable cat gate has led to the exploration of innovative design principles that deviate from traditional gate configurations. The ideal solution would accommodate a wide range of architectural peculiarities, including the absence of door frames and variable doorway heights, without compromising on ease of use or the aesthetic integration into domestic environments. Such advancements in cat gate design are pivotal in addressing the multifaceted challenges faced by pet owners, aiming to enhance the quality of life for both pets and their human companions by fostering an environment of safety, visibility, and unrestricted access within the constraints of controlled boundaries.

It is within this context that the present invention is provided.

### SUMMARY

The present invention pertains to a cat gate system designed to selectively restrict or allow passage of cats through a passageway between two opposing walls. This system incorporates a pair of horizontal telescopic rods equipped with mounting pads for secure installation, a fixed vertical side rod, a vertically mounted sliding side rod with a mechanism for slidable engagement, and a net that stretches across the space to block or permit passage. This configuration allows for adjustable installation and operational flexibility, accommodating a wide range of architectural spaces and user needs.

In some embodiments, the telescopic nature of the horizontal rods and the fixed side rod permits adjustments in width and height, enhancing the system's adaptability to different spaces and installation requirements. This feature provides significant versatility, enabling the cat gate system to be installed in a variety of locations, including those without standard door frames.

The inclusion of horse-shoe shackles for the slidable engagement of the sliding side rod, as described in some embodiments, facilitates smooth and reliable sliding motion. This design choice ensures ease of use and contributes to the system's overall functionality and user-friendly operation.

In certain embodiments, the net is equipped with sleeves along its side edges, which are designed to accommodate the fixed and sliding side rods. This feature aids in maintaining the net's orientation and structural integrity, ensuring effective containment and passage control.

The system may also incorporate a plurality of rings coupling the net's edges to the telescopic rods, as outlined in some embodiments. These rings allow for easy adjustment of the net's tension and positioning, contributing to the system's flexibility and ease of use.

Attachment mechanisms, including magnetic fixtures and options such as hooks, latching mechanisms, friction locks, and snap-fit connections, are provided in some embodiments to secure the gate in a closed position. These mechanisms offer a range of securing options to suit various installation environments and user preferences.

A protective piece designed to prevent interference with the attachment mechanism is included in some embodiments. This piece safeguards the integrity of the gate's closed position, enhancing the system's reliability and functionality.

To accommodate adjustments in the net's width and ensure a snug fit, some embodiments incorporate clips for securing loose netting material against the fixed side rod. This feature allows for customizable gate width, enhancing the system's adaptability to different passageway sizes.

Materials selected for the net and the structural components of the gate system, as specified in some embodiments, include durable and transparent options for the net and sturdy, wear-resistant materials for the rods. These choices ensure the system's durability, functionality, and aesthetic integration into domestic environments.

Furthermore, the design of the mounting pads, including their shape and the inclusion of cushioned portions in some embodiments, facilitates secure and damage-free attachment to wall surfaces. This consideration enhances the system's practicality and user-friendliness by ensuring easy installation and removal without compromising wall integrity.

### BRIEF DESCRIPTION OF THE DRAWINGS

Various embodiments of the invention are disclosed in the following detailed description and accompanying drawings.

FIG. 1 illustrates an example configuration of the cat gate in a closed position, showing the entire system installed across a space with the net fully stretched and secured.

FIG. 2 illustrates an example where the cat gate is shown in an open position, with the sliding side rod pulled closer to the fixed rod, allowing passage through the space.

FIG. 3 illustrates an example close-up view of the mounting pad on the top rod, the top of the sliding side rod, and the magnetic fixture that holds the gate in a closed position.

FIG. 4 illustrates an example close-up of the opposite side of the top rod, showing the top of the fixed side rod and the clips holding excess netting to manage the net's tension and coverage.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “top” “bottom” “upper,” etc., is used for ease of explanation to describe the relationship between elements when the apparatus is in its proper orientation.

The terms “first,” “second,” and the like are used to distinguish different elements or features, but these elements or features should not be limited by these terms. A first element or feature described can be referred to as a second element or feature and vice versa without departing from the teachings of the present disclosure.

For the purposes of this patent, the term ‘telescopic rods’ refers to any elongated members capable of length adjustment through sliding or overlapping sections, including but not limited to segments that slide within each other or extend side by side. Example materials for these rods include aluminum, stainless steel, and reinforced plastic due to their strength, lightweight properties, and resistance to corrosion.

The term ‘mounted’ encompasses a range of attachment mechanisms including, but not limited to, screws, adhesives, clamps, and any other means that can securely affix the rods to a variety of wall surfaces without causing damage.

Where elements of the cat gate system are described as ‘attached,’ ‘coupled,’ or ‘connected,’ this includes both direct attachment where elements are physically joined together without any intervening elements, and indirect attachment where elements may be joined together with one or more intervening elements present. This is intended to cover, for example, the use of fasteners, welding, adhesive bonding, and removable connectors such as hooks and loops, magnetic couplings, and snap-fit connectors to facilitate assembly and disassembly.

The use of ‘magnetic fixtures’ as described may include various types of magnets such as neodymium magnets, ferrite magnets, or samarium-cobalt magnets. These magnets may be used in attachment mechanisms to secure the sliding side rod in a closed or open position against the wall or another part of the cat gate system. The choice of magnet type will depend on the required magnetic strength, durability, and cost considerations.

The operational mechanism for the sliding side rod, detailed as a ‘means for slidable engagement,’ includes, but is not limited to, configurations such as horse-shoe shackles, linear bearings, and track systems. These mechanisms are selected to ensure smooth, reliable movement of the sliding side rod along the horizontal telescopic rods, facilitating the easy adjustment of the gate's position.

The ‘net’ described within the cat gate system may be made from materials including nylon mesh, polyester mesh, or polyethylene mesh. These materials are chosen for their durability, resistance to cat claws, and transparency. The net may be attached to the rods using various methods, including but not limited to, threading through sleeves, hooking onto rings, or clipping onto fasteners, allowing for easy installation and removal.

### DESCRIPTION OF DRAWINGS

The present detailed description sets forth a cat gate system, designed to address the specific needs of pet containment within domestic and similar environments. This invention introduces an innovative approach to controlling the movement of cats in and around various spaces, such as doorways and hallways, without the need for permanent structural alterations or the limitations imposed by traditional pet gate designs.

The cat gate system utilizes a pair of horizontal telescopic rods that can be adjusted to span the width of a passageway between two opposing walls. These rods serve as the structural framework for the gate, providing both the top and bottom boundaries of the barrier. Mounted on these telescopic rods are a fixed side rod and a sliding side rod, both oriented vertically. The sliding side rod's position can be adjusted along the horizontal axis, enabling the gate to be expanded or contracted to block or allow passage through the area it secures. A net attaches between the fixed and sliding side rods. This net is designed to be transparent or semi-transparent, ensuring that pets can see through the barrier, reducing potential stress or anxiety caused by visual isolation. The net's material and construction are selected for durability and resistance to climbing or scratching by cats, while still being lightweight and easy to manipulate for humans.

To accommodate a wide variety of installation environments and user preferences, the system includes various attachment mechanisms for the telescopic rods and the net. These mechanisms are designed for ease of installation and removal, minimizing the impact on the structural elements of the installation space. Magnetic fixtures, clips, and other forms of attachment allow for the gate to be securely positioned when in use and easily retracted or removed when access is needed.

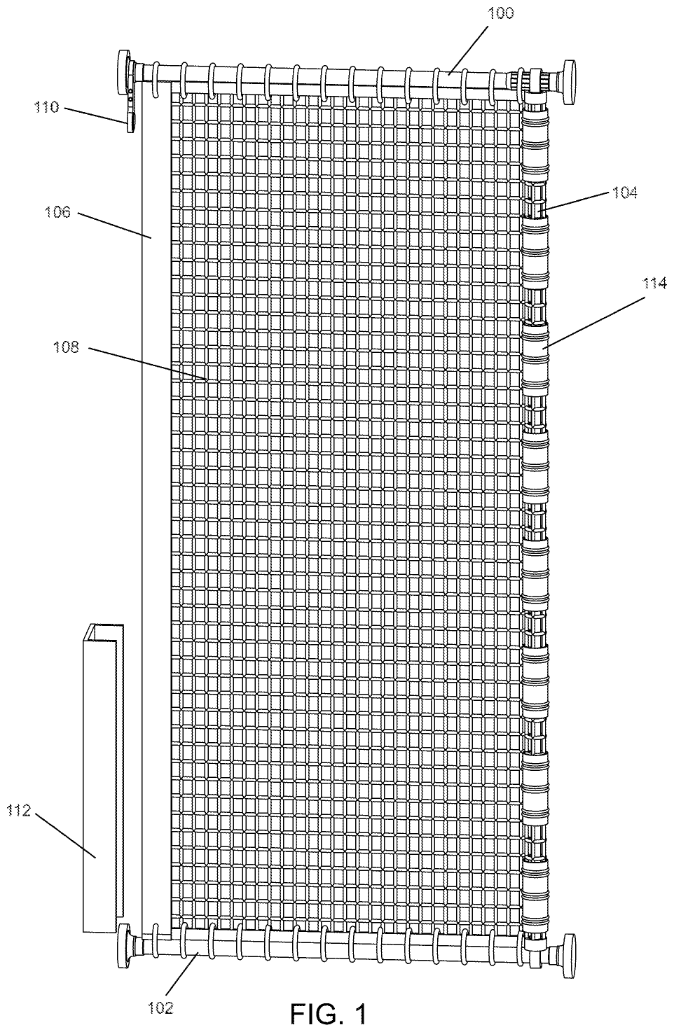

FIG. 1 presents an isometric view of the cat gate system in a closed position, illustrating its components and assembly within a typical installation environment. The figure showcases the cat gate installed across a passageway between two opposing walls, demonstrating the system's operational state for pet containment.

The pair of horizontal telescopic rods 100 and 102, each with a first end and a second end, are shown extending across the passageway. These rods are mounted to the opposing walls using mounting pads located at their ends. The materials for these rods can include aluminum, stainless steel, or reinforced plastic, chosen for their durability and ease of extension or retraction. The mounting pads are designed to securely attach the rods to the walls without causing damage, potentially featuring cushioned or soft contact surfaces to protect wall finishes.

A fixed side rod 104 is depicted at one end of the telescopic rods, anchored in a vertical orientation. This rod serves as one of the boundary elements for the net 108, ensuring that one side of the net remains stationary. Adjacent to the fixed side rod 104, a sliding side rod 106 is illustrated. The sliding side rod 106 is capable of moving along the horizontal telescopic rods 100 and 102, providing adjustability to the system. The sliding motion is facilitated by horse-shoe shackles or similar mechanisms, enabling smooth and controlled movement.

The net 108, attached between the fixed side rod 104 and the sliding side rod 106, is stretched fully across the passageway, blocking passage. The net is made from materials such as nylon mesh, polyester mesh, or polyethylene mesh, selected for their combination of durability, transparency, and resistance to climbing. The top and bottom edges of the net are coupled to the horizontal telescopic rods 100 and 102, while sleeves or similar structures along the side edges of the net accommodate the vertical rods.

Magnetic fixtures 110 are employed to hold the sliding side rod 106 in the distal position from the fixed rod 104, ensuring the net 108 remains taut and in place. These fixtures can be positioned at strategic points along the telescopic rods and the sliding side rod, providing a secure yet easily releasable connection.

A protective piece 112 is positioned at the bottom of the installation, designed to receive the sliding side rod 106. This piece prevents accidental dislodgement of the sliding rod and protects the mechanism from interference or damage. The protective piece can be constructed from materials that complement the overall design, offering additional stability and security.

Clips 114 are shown attaching excess netting to the fixed side rod 104, adjusting the width of the net to ensure a snug fit across the passageway. These clips allow for customization of the net's coverage, accommodating variations in the width of the installed space and ensuring that there are no gaps through which a cat could pass.

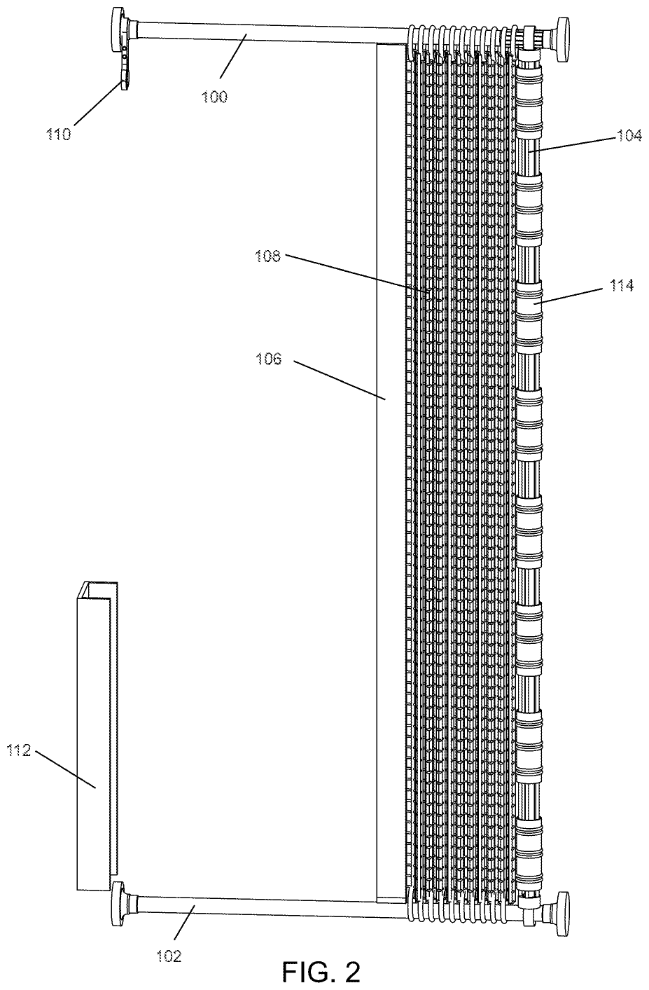

FIG. 2 illustrates the cat gate system in an open position, where the sliding side rod 106 has been moved closer to the fixed side rod 104, compressing the net 108 and allowing for passage through the space previously blocked by the cat gate.

The fixed side rod 104 remains stationary, anchored between the horizontal telescopic rods at one end of the passageway. The sliding side rod 106, in contrast to its position in FIG. 1, is shown drawn towards the fixed side rod 104, effectively gathering the net 108 and creating an open space for passage. The mechanism for sliding, which may include horse-shoe shackles or similar devices, allows for smooth movement of the sliding side rod 106 along the horizontal telescopic rods 100 and 102.

The net 108, previously stretched across the passageway in FIG. 1, is now gathered or bunched near the fixed side rod 104, thanks to the movement of the sliding side rod 106.

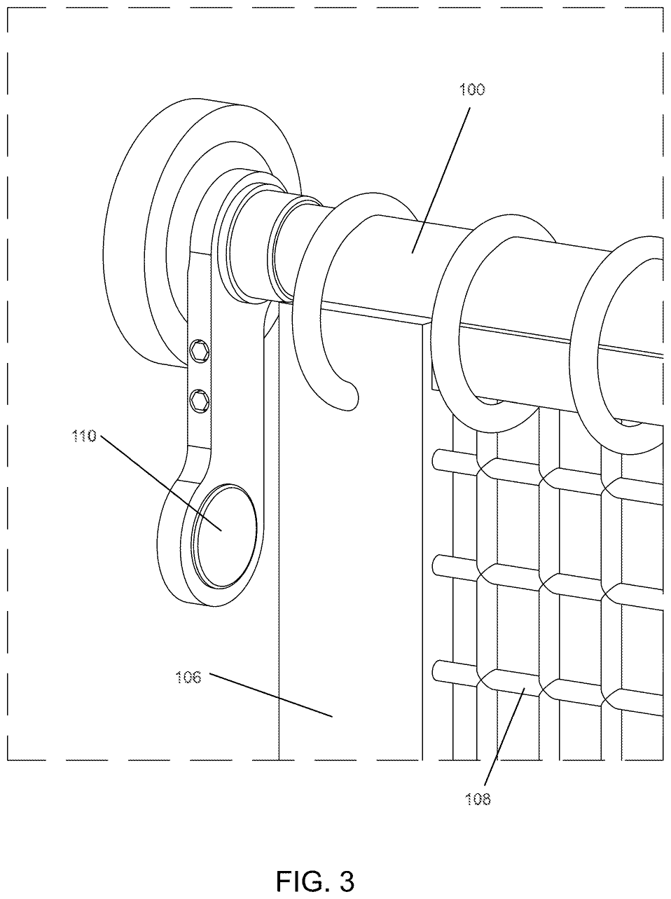

FIG. 3 provides a detailed close-up view of the mounting pad of the top horizontal telescopic rod 100, the top portion of the sliding side rod 106, and the magnetic fixture 110, illustrating the mechanism by which the cat gate system is held in a closed position.

The mounting pad at the end of the top horizontal telescopic rod 100 is shown in greater detail, revealing its design that allows for secure attachment to the wall. The mounting pad is engineered to distribute the load evenly across the wall surface, minimizing potential damage while providing a stable anchor for the rod. Materials for the mounting pad may include a durable metal core with a soft, non-marring perimeter or coating to protect the wall surface upon installation.

The top of the sliding side rod 106 is depicted in proximity to the mounting pad, showcasing the means by which it engages with the horizontal telescopic rod 100. The sliding side rod 106 features a mechanism, such as a bracket or a sleeve, that facilitates smooth sliding along the rod while maintaining its vertical orientation. This design allows for easy adjustment of the gate's width by manually moving the sliding side rod towards or away from the fixed side rod 104.

Central to FIG. 3 is the magnetic fixture 110, positioned to secure the sliding side rod 106 in place when the cat gate is in its closed configuration. The magnetic fixture employs a magnet, potentially a neodymium magnet for its strong magnetic force, affixed to the end of the horizontal telescopic rod 100 or incorporated within the mounting pad. The corresponding metal component or a second magnet on the sliding side rod 106 aligns with the fixture when the gate is extended to its desired width, ensuring a secure closure. This magnetic coupling is designed for ease of use, allowing for quick and effortless securing or releasing of the gate with minimal force required.

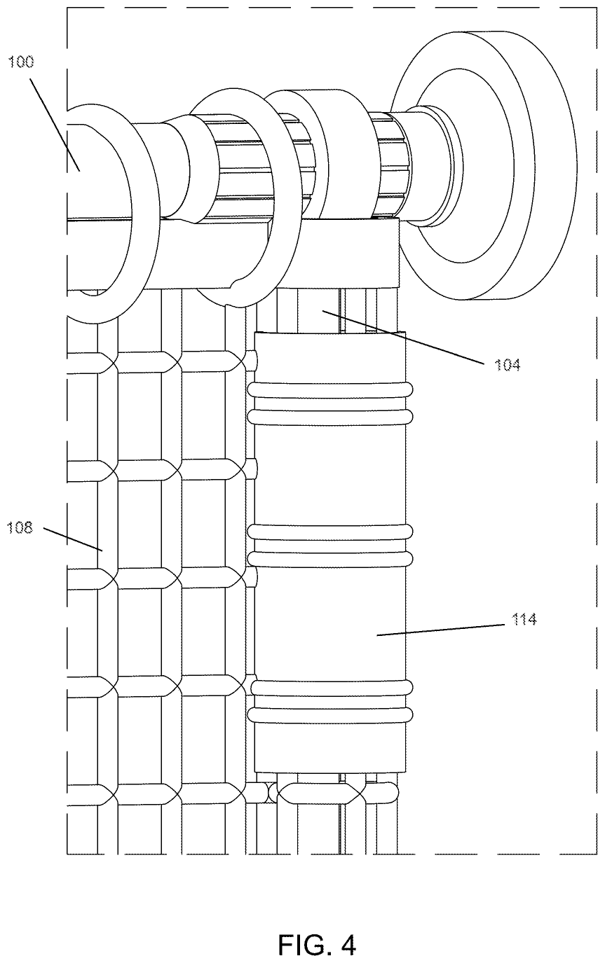

FIG. 4 offers a focused close-up view of the opposing side of the top horizontal telescopic rod 102, detailing the top portion of the fixed side rod 104 and the clips 114 that manage excess netting.

At the top of the fixed side rod 104, visible on this side of the gate, a connection point or bracket is shown, which secures the rod to the top horizontal telescopic rod 102. FIG. 4 highlights the use of clips 114 to manage and secure excess netting. These clips attach the extra material of the net 108 to the fixed side rod 104, ensuring that the net remains taught and functional, regardless of the gate's width. The clips are designed for easy repositioning, allowing users to adjust the amount of netting used as needed and to maintain the net's effectiveness as a barrier. The material and design of the clips ensure durability and ease of use, complementing the gate's design for user convenience and pet safety.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the cat gate device of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A cat gate system comprising:
a pair of horizontal telescopic rods, each rod having a first end and a second end, wherein each of the horizontal telescopic rods includes a mounting pad at the first end and the second end for securing the rod between two opposing walls;
a fixed side rod oriented vertically and secured between the pair of horizontal telescopic rods at a first end of the pair, wherein the fixed side rod is positioned adjacent to one of the opposing walls;
a sliding side rod mounted vertically between the pair of horizontal telescopic rods and capable of sliding between the fixed side rod and the second end of the pair of horizontal telescopic rods while maintaining a vertical orientation, wherein the sliding side rod includes a means for slidable engagement with the pair of horizontal telescopic rods;
a net attached between the fixed side rod and the sliding side rod, the net further comprising top and bottom edges, wherein the top edge is coupled to the top horizontal telescopic rod and the bottom edge is coupled to the bottom horizontal telescopic rod, and wherein the net is configured to be stretched across the pair of horizontal telescopic rods to block a passageway between the two opposing walls when the sliding side rod is positioned near the second end of the pair of horizontal telescopic rods, and to allow passage when the net is compressed by moving the sliding side rod towards the fixed side rod.

2. The cat gate system of claim 1, wherein the pair of horizontal telescopic rods and the fixed side rod are telescopic to allow for variation in the distance between the two opposing walls and the height of the cat gate system.

3. The cat gate system of claim 1, wherein the means for slidable engagement comprises horse-shoe shackles allowing for the sliding movement of the sliding side rod between the fixed side rod and the second end of the pair of horizontal telescopic rods.

4. The cat gate system of claim 1, wherein the net further comprises sleeves along its side edges, the sleeves configured to receive the fixed side rod and the sliding side rod to maintain the net's vertical orientation.

5. The cat gate system of claim 1, further comprising a plurality of rings coupling the top edge and the bottom edge of the net to the pair of horizontal telescopic rods.

6. The cat gate system of claim 1, further comprising attachment mechanisms for holding the gate in a closed position coupled to the second end of at least one of the pair of horizontal telescopic rods, to hold the sliding side rod in place against one of the opposing walls.

7. The cat gate system of claim 6, wherein the attachment mechanisms comprise magnetic fixtures.

8. The cat gate system of claim 6, wherein the attachment mechanism is selected from the group consisting of: hooks, latching mechanisms, friction locks, and snap-fit connections, each configured to engage with the sliding side rod and maintain the net in a stretched position across the passageway.

9. The cat gate system of claim 1, further comprising a protective piece positioned on the wall adjacent to the second end of the bottom horizontal telescopic rod, the protective piece comprising an elongate body with a pair of wings forming a groove to receive a portion of the sliding side rod, thereby preventing interference with the attachment mechanism.

10. The cat gate system of claim 1, further comprising clips for holding loose netting material against the fixed side rod to adjust the width of the net and ensure a snug fit across the passageway.

11. The cat gate system of claim 1, wherein the net is composed of materials selected from the group consisting of nylon mesh, polyester mesh, and polyethylene mesh, each material being capable of providing durability, transparency, and resistance to climbing by cats.

12. The cat gate system of claim 1, wherein the pair of horizontal telescopic rods, the fixed side rod, and the sliding side rod are constructed from materials selected from the group consisting of aluminum, stainless steel, and reinforced plastic.

13. The cat gate system of claim 1, wherein the mounting pads at the first and second ends of the pair of horizontal rods are of a shape configured to facilitate secure attachment to a variety of wall surfaces and to distribute the load evenly to prevent damage to the walls.

14. The cat gate system of claim 1, wherein the mounting pads at the first and second ends of the pair of horizontal rods comprise cushioned portions of a softer material on the surface interfacing with the walls to prevent damage to the walls.
